(19) United States
(12) Patent Application Publication
(10) Pub. No.: US 2024/0065350 A1
(43) Pub. Date: Feb. 29, 2024

(54) HOOD WITH INTEGRATED FACE AND NECK GUARD

(71) Applicant: Krystyna Lakota, Middle Village, NY (US)

(72) Inventor: Krystyna Lakota, Middle Village, NY (US)

(21) Appl. No.: 17/895,161

(22) Filed: Aug. 25, 2022

(51) Int. Cl. A41D 13/11; A41D 13/05; A62B 17/04

(52) U.S. Cl. CPC A41D 13/1153; A41D 13/0512; A62B 17/04

(57) ABSTRACT

A hooded garment comprises a garment adapted to be worn on a user's torso, the garment having a neck region adapted to be positioned around the user's neck, a hood attached to the garment at the neck region and adapted to cover the user's head when the user desires to use the hood, the hood, when worn by the user, having an opening defining a perimeter around the user's face, and a facial covering attached to the hood around at least a portion of the perimeter and adapted to selectively cover the user's face, when the facial covering is desired to be used, and be stowed inside the hood when the facial covering is not desired to be used. The hooded garment may further include a neck portion that extends downwardly from the facial covering to cover the user's neck when the facial covering is used.

### FIELD OF THE INVENTION

The present invention relates to the field of protective apparel or garments, such as jackets, parkas, windbreakers, shells, sweaters, jumpsuits, etc., in particular for hoods used in connection with such garments.

### BACKGROUND

Outdoor wear that covers a user's upper torso often includes a hood, which will protect the top of the user's head and the back of the neck. However, in cold/hot/windy weather there is many times a need for protection of a user's face and the front of the neck against cold weather, ultraviolet rays, wind, dust, as well as hazards such as flying debris. Thus, a user who wishes to protect their face and neck is forced to keep a face guard or covering handy, store it in a garment pocket, wear it when needed, remove it and store it again when not needed. In addition to inconvenience, this routine it makes difficult and uncomfortable to put on a face guard while outside during inclement weather.

As used herein, the terms “guard” and “covering” are synonymous and may be used interchangeably, as are the terms “apparel” and “garment”, which are synonymous and may be used interchangeably.

### SUMMARY OF THE INVENTION

Accordingly, it is an object of the present invention to provide a garment with a hood having an integrated face and neck guard, which is always conveniently handy whenever an individual needs to protect their face and neck, thus avoiding the difficulties referenced above.

In accordance with examples of the present invention, a hooded garment comprises a garment adapted to be worn on a user's torso, the garment having a neck region adapted to be positioned around the user's neck, a hood attached to the garment at the neck region and adapted to cover the user's head when the user desires to use the hood, the hood, when worn by the user, having an opening defining a perimeter around the user's face, and a facial covering attached to the hood around at least a portion of the perimeter and adapted to selectively cover the user's face, when the facial covering is desired to be used, and be stowed inside the hood when the facial covering is not desired to be used. The hooded garment may further include a neck portion that extends downwardly from the facial covering to cover the user's neck when the facial covering is used. The facial covering can be attached to the hood along the sides and top of the opening approximately 2-4 inches from the perimeter, and may be permanently affixed to the hood by one of stitching, thermally fusion, and adhesively bonding or releasably detachable from the hood by one of a zipper or Velcro® type fastener. The facial covering preferably includes openings for the user's eyes and mouth, and the opening for the user's mouth may include a filter material.

In accordance with examples of preferred embodiments, the facial covering may be comprised of a breathable, 4-way stretch fabric, one or more materials selected from the group comprising cotton, linen, wool, leather, silk, modal, bamboo, rayon, polyester, nylon, acrylic, and elastane, materials that form blends, laminates or sequentially joined materials, materials that include one or more of waterproof and breathable membranes, insulation layers, wicking layers, and reflective coatings, single, integral ply of one or more materials and form an integral laminate of plies, materials having an outer layer of one of polyester and nylon and an inner layer having waterproof breathable properties, where the inner layer is comprised of a moisture-absorbent layer or an insulating layer, and multiple plies of material may be used in the user's forehead area, to provide extra warmth, and a single ply in the user's mouth and nose area.

### BRIEF DESCRIPTION OF THE DRAWINGS

These and other objects and aspects of the present invention will be described with reference to the following drawing figures, of which:

FIG. 1 is a frontal view of a user wearing a garment having a hood with an integrated face and neck covering in accordance with an example of the present invention;

FIG. 2 is a frontal view of the garment of FIG. 1 with the integrated face and neck covering in a stowed position, in accordance with an example of the present invention;

FIG. 3 is a side view of a user wearing the garment having a hood with an integrated face and neck covering, as depicted in FIG. 1, in accordance with an example of the present invention;

FIG. 4 is a side view of the garment with the integrated face and neck covering in a stowed position, as depicted in FIG. 2, in accordance with an example of the present invention; and

FIG. 5 is a perspective view of the garment while the hood of is not used by the user, showing the integrated face and neck covering in a stowed position, in accordance with an example of the present invention.

### DETAILED DESCRIPTION OF THE INVENTION

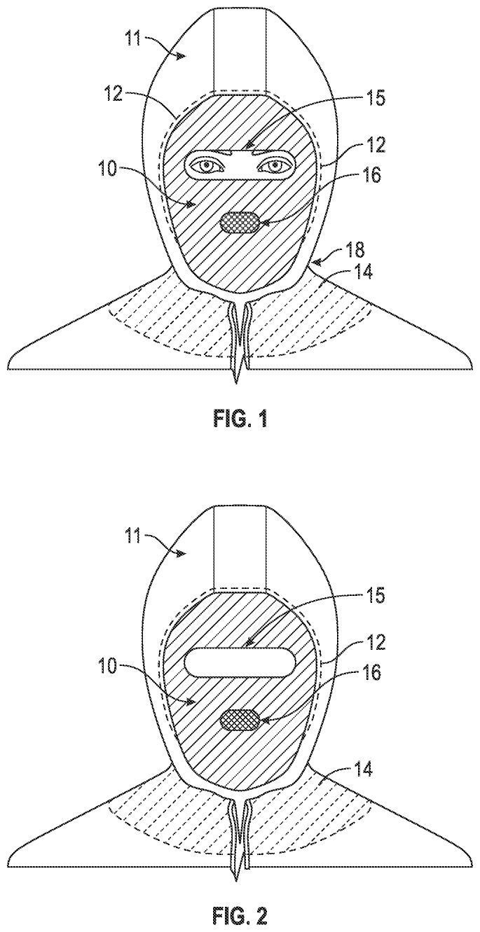

A garment with a hood having an integrated face and neck guard, in accordance with an example of the present invention, is shown in FIGS. 1-5. The garment can be a jacket, parka, windbreaker, shell, sweater, jumpsuit, or the like. The garment is provided with a hood 11, which is attached to the garment at neck region 18, and face and neck guard which is permanently affixed to the inside of hood 11. The upper part of the covering forms the face portion of the guard 10, and the lower part of the guard forms the neck portion of the guard 14. Although the guard is preferably large enough to cover both the head and neck, it may be designed to cover the head only, if desired.

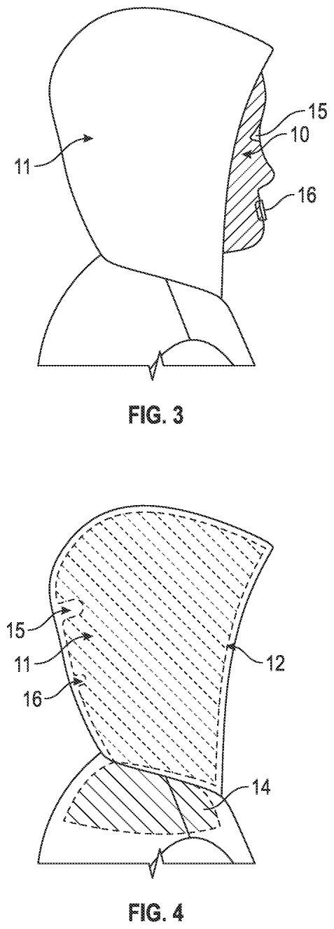

As best shown in FIGS. 1 and 2, the face portion of the guard 10 is preferably sewn, thermally fused, adhesively bonded, or otherwise permanently affixed around the sides and top portions of the hood 11, approximately 2-4 inches from the perimetrical edge of the hood, at seam 12, with the neck portion 14 extending down over the user's neck, the face and neck guard thereby fitting snugly against the user's face and neck, as shown in FIGS. 1 and 3. If desired, however, the guard may be releasably detachable from the hood by means of a zipper or Velcro® type fastener, or the like. The part of the guard in the area of the user's chin is not attached to the garment, to thereby allow the guard to be pulled over the user's head or removed.

Openings 15 and 16 are provided around the eyes and mouth regions, respectively. Opening 16 over the mouth region may include a filter-like material such as a mesh fabric to exclude debris from entering while allowing the user to breath and speak. The face portion 10 of the guard can be contoured in a well-known manner, using seams or the like, to further ensure a snug fit. Thus, the upper and lower portions of the guard will thereby protect a user's face, ears, neck and top portion of torso against cold weather, the ultraviolet rays, wind, dust, as well as hazards such as flying debris.

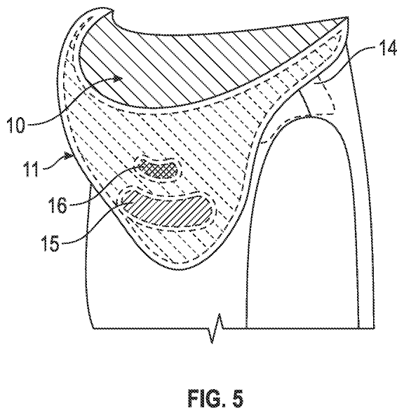

As shown in FIGS. 2 and 4, the user may choose not to use the face and neck guard, in which case, the guard may be stowed and lay flat inside the hood. Similarly, as shown in FIG. 5, the guard 10 may be stowed and lay flat inside the hood when the hood is not in use. In either case, because of the configuration described above, the guard will lie flat within the hood and the neck portion of the garment, and not unduly or negatively affect the bulk or contour of the garment when the guard is not in use.

The face guard 10 preferably consists of a warm, soft, breathable, 4-way stretch or similar fabric. If desired, the guard can be made from the same material as the rest of the garment. Examples of materials for the guard include various textures of natural and synthetic textiles like cotton, linen, wool, leather, silk, modal, bamboo, rayon, polyester, nylon, acrylic, elastane, and combinations of the foregoing, either as blends, laminates of one or more plies of the same or different sheet materials, or sequentially joined materials. The guard may include functional sheet materials and coatings, such as waterproof and breathable membranes, insulation layers, wicking layers, and reflective coatings. The plies may be a single, integral ply of one or more materials and form an integral laminate of plies. The guard could have an outer layer of a durable material such as polyester or nylon and an inner layer having waterproof breathable properties. An inner or intermediate layer could also be a moisture-absorbent layer or an insulating layer. The guard may have multiple plies in just the forehead area to provide more insulation, with mouth and nose area in a single ply to allow ventilation.

Thus, the present invention thus provides a garment with a hood having an integrated face and neck guard, which is always conveniently handy whenever an individual needs to protect their face and neck from wind, dust, dirt, rain or other inclement weather conditions.

It will be understood that various additional changes in the details, materials and arrangements of parts which have been herein described and illustrated in order to explain the nature of the invention may be made by those skilled in the art within the principle and scope of the invention as expressed in the following claims.

I claim:

1. A hooded garment comprising:
a. a garment adapted to be worn on a user's torso, said garment having a neck region adapted to be positioned around said user's neck;
b. a hood attached to said garment at said neck region and adapted to cover said user's head when said user desires to use said hood, said hood, when worn by the user, having an opening defining a perimeter around said user's face; and
c. a facial covering attached to said hood around at least a portion of said perimeter and adapted to selectively
i. cover said user's face, when said facial covering is desired to be used; and
ii. be stowed inside said hood when said facial covering is not desired to be used.

2. The hooded garment of claim 1 wherein said facial covering further includes a neck portion that extends downwardly from said facial covering to cover said user's neck when said facial covering is used.

3. The hooded garment of claim 1 wherein said facial covering is attached to said hood along the sides and top of said opening.

4. The hooded garment of claim 3 wherein said facial covering is attached to said hood approximately 2-4 inches from said perimeter.

5. The hooded garment of claim 3 wherein said facial covering is permanently affixed to said hood by one of stitching, thermally fusion, and adhesively bonding.

6. The hooded garment of claim 3 wherein said facial covering is releasably detachable from the hood by one of a zipper or Velcro®.

7. The hooded garment of claim 3 wherein said facial covering includes openings for said user's eyes and mouth.

8. The hooded garment of claim 7 wherein said opening for said user's mouth includes a filter material.

9. The hooded garment of claim 3 wherein said facial covering is comprised of a breathable, 4-way stretch fabric.

10. The hooded garment of claim 3 wherein said facial covering is comprised of one or more materials selected from the group comprising cotton, linen, wool, leather, silk, modal, bamboo, rayon, polyester, nylon, acrylic, and elastane.

11. The hooded garment of claim 3 wherein said facial covering is comprised of materials that form blends, laminates or sequentially joined materials.

12. The hooded garment of claim 3 wherein said wherein said facial covering is comprised of materials that include one or more of waterproof and breathable membranes, insulation layers, wicking layers, and reflective coatings.

13. The hooded garment of claim 3 wherein said wherein said facial covering is comprised of a single, integral ply of one or more materials and form an integral laminate of plies.

14. The hooded garment of claim 3 wherein said wherein said facial covering is comprised of materials having an outer layer of one of polyester and nylon and an inner layer having waterproof breathable properties.

15. The hooded garment of claim 14 wherein said inner layer is comprised of a moisture-absorbent layer.

16. The hooded garment of claim 14 wherein said inner layer is comprised of an insulating layer.

17. The hooded garment of claim 3 wherein said facial covering is comprised of multiple plies in said user's forehead area and a single ply in said user's mouth and nose area.
